(19) United States
(12) Patent Application Publication
(10) Pub. No.: US 2026/0351437 A1
(43) Pub. Date: Nov. 5, 2026

(54) DEUTERON BREAKUP NEUTRON TARGET FOR ISOTOPE PRODUCTION

(71) Applicant: THE REGENTS OF THE UNIVERSITY OF CALIFORNIA, Oakland, CA (US)

(72) Inventors: Lee BERNSTEIN, Berkeley, CA (US); Dajie SUN, Berkeley, CA (US); Andrew VOYLES, Berkeley, CA (US)

(21) Appl. No.: 19/109,067

(22) PCT Filed: Sep. 8, 2023
(86) PCT No.: PCT/US2023/032259

§ 371 Date: Mar. 5, 2025

Related U.S. Application Data
(60) Provisional application No. 63/404,993, filed on Sep. 9, 2022.

(51) Int. Cl. G21G 1/06; G21G 4/02

(52) U.S. Cl. CPC G21G 1/06; G21G 4/02

(57) ABSTRACT

A target assembly capable of producing a neutron flux with a sufficient flux and energy distribution based on accelerator-driven thick target deuteron breakup includes a low-Z deuteron breakup target and a supporting structure in which the deuteron break-up target is located. The target may be formed, for example, from graphite, metallic beryllium, a beryllium-water combination or liquid lithium. The supporting structure may be formed from a material with a high thermal conductivity because of the high heat flux that is generated at the location of the target.

### CROSS-REFERENCE TO RELATED APPLICATION

This application claims the benefit of U.S. Provisional Application Ser. No. 63/404,993, filed Sep. 9, 2022, the contents of which are incorporated herein by reference.

### GOVERNMENT FUNDING

This invention was funded by an award from the Department of Energy, award number DE-AC02-05CH11231. The government has certain rights to the invention.

### BACKGROUND

High flux (e.g., greater than 10¹² n/s/cm²) neutron beams with energies between 2 and 25 MeV are needed for a number of applications including radioisotope production and materials testing for advanced nuclear fission and fusion materials science development. However, none of the current suite of neutron sources can meet these needs, with typical neutron DT (Deuterium-tritium fusion) and DD (Deuterium-Deuterium fusion) neutron source flux intensities being 2+ orders of magnitude too low and high-energy proton accelerator-driven spallation sources having a spectral component 1-2 orders of magnitude too high.

### SUMMARY

Described herein are systems and methods for producing a high flux beam of multi-MeV neutrons. In particular, a target system or assembly is disclosed to efficiently and effectively make a very high flux of neutrons through the mechanism of deuteron breakup.

In one aspect of the subject matter described herein, a target system or assembly capable of producing a neutron flux with a sufficient flux and energy distribution based on accelerator-driven thick target deuteron breakup and a secondary neutron source that includes the capability to perform simultaneously deuteron-irradiation of a separate sample suitable for use in both isotope production and materials damage studies.

In another aspect of the subject matter described herein, the target assembly includes a low-Z deuteron breakup target and a supporting structure in which the deuteron break-up target is located. In some illustrative examples the target is formed from graphite, metallic beryllium, a beryllium-water combination or liquid lithium. In some embodiments, the supporting structure is formed from a material with a high thermal conductivity because of the high heat flux that is generated at the location of the target. For instance, in illustrative examples, the supporting structure is formed from copper, although other high thermal conductivity materials such as aluminum may be used instead. The target assemblies that include the graphite or metallic beryllium targets may also employ a fast-flowing liquid water coolant to further remove heat from the assembly. In some other embodiments, a silicon-carbide (Si—C) supporting structure may be employed as well.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic illustration of a first example of a target assembly that employs a graphite target.

FIG. 2 shows temperature maps for the target assembly shown in FIG. 1.

FIG. 3 is a schematic illustration of a second example of a target assembly, which employs a beryllium target.

FIG. 4 shows temperature maps for the target assembly shown in FIG. 3.

FIG. 5a is a schematic illustration of a third example of the target assembly and FIG. 5b shows the target breakup section of this example of the target assembly.

FIG. 6a is a schematic illustration of an alternative embodiment of the third example of the target assembly and FIG. 6b shows the target breakup section of this embodiment of the target assembly.

FIG. 7 is a schematic illustration of another example of the target assembly, which employs a liquid lithium target.

FIG. 8 is a schematic illustration of one embodiment of the second example of the target assembly shown in FIG. 3 that employs a beryllium target.

FIGS. 9a-9g show examples of roughened surfaces that may be provided at the interface between the water in the water channels and the target assembly body for the embodiment of the target assembly shown in FIG. 8

FIG. 10 is a schematic illustration of another embodiment of the target assembly shown in FIG. 8.

FIG. 11 shows an alternative embodiment of the break-up target section for the target assembly shown in FIGS. 5 and 6.

### DETAILED DESCRIPTION

Described herein are various illustrative embodiments of a target assembly for producing a high flux neutron beam from deuteron breakup. The neutron beams that are produced by the target assembly from deuteron breakup may be used to irradiate one or more secondary targets, which in turn may be used, for example, to produce radioisotopes via neutron-induced reactions. For example, the target assembly could be used in conjunction with the isotope production mechanism described in co-pending U.S. patent application Ser. No. 17/602,056, entitled “Systems and Methods for Producing Actinium-225,” which is incorporated by reference herein in its entirety. For this purpose, some embodiments of the target assemblies are generally designed to be relatively thin so that the secondary target can be located behind and relatively close to the deuteron break-up target. In this way the neutron flux irradiating the secondary target can be maintained at a high level.

Illustrative, non-limiting examples of the target assembly are presented below. It should be noted that all dimensions and other numerical values are presented by way of illustration only and not as a limitation on the systems and methods described herein.

### Graphite Target Assembly Design

A first example of the target assembly described herein includes a graphite break-up target that includes a thin (50 μm) enriched ¹⁸⁶W target for use in producing ¹⁸⁶Re via the (d,2n) reaction. One particular implementation of this first example of the target assembly is designed so that it meets the following goals:
1. The target accepts 1 cm diameter 35 MeV deuteron beam;
2. A total beam power of 10 and 20 KW (e.g., beam intensity is 286 to 571 μA);
3. A graphite break-up target;
4. A body or fixture of easy-to-machine 145 copper
5. A fast-flowing liquid water coolant;
6. A minimum separation between the breakup target and the backing where an isotope production target driven by secondary neutrons is to be located.

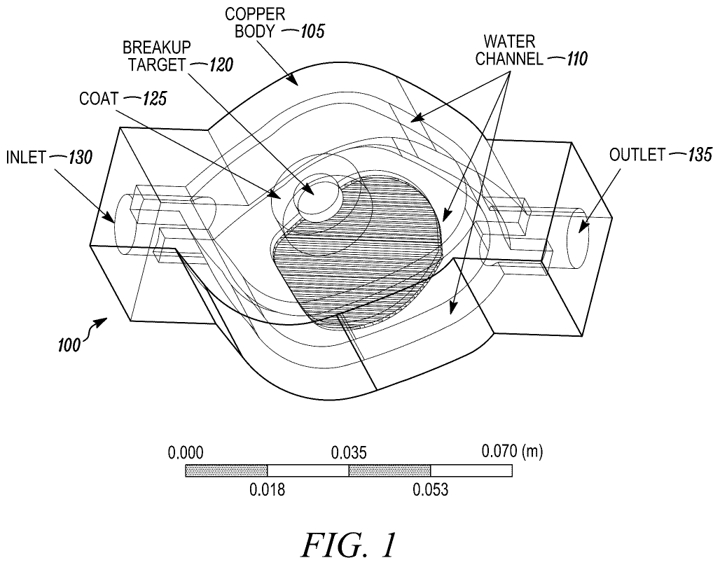

FIG. 1 shows a schematic illustration of this first example of the target assembly 100. As shown, the target assembly includes a fixture or body 105 formed completely of 145 copper. The copper body 105 includes therein a water channel 110 having an inlet 130 and outlet 135. The copper body 105 also supports a graphite cylinder that has two parts. The first inner part serves as the break-up target 120. In one particular example the breakup target is a right cylinder having a 1 cm radius and a 3 mm length. A cylindrical graphite “coat” 125 surrounds breakup target 120. In one example the graphite coat is 1 cm thick.

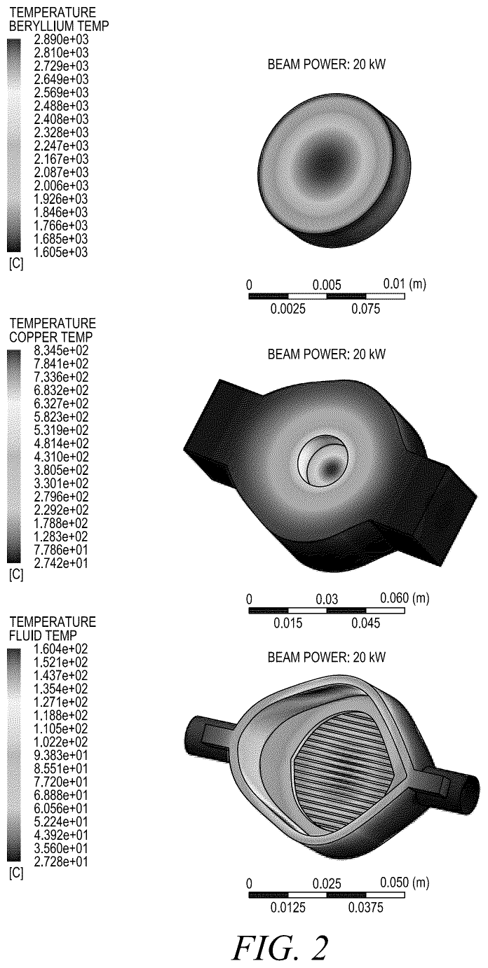

Thermal conditions throughout the target assembly shown in FIG. 1 have been modeled assuming a pump rate of 20 gallons/minute, with an entry pressure of 2 bars and the outflow with a pressure of 1 bar. These thermal conditions for the different constituents of the target assembly are shown in the temperature maps of FIG. 2, which are depicted in grayscale. The top panel shows the temperature map for the graphite break-up target and the graphite coat. The middle panel shows the copper body temperature. The bottom panel shows a temperature map of the cooling water. There are no points in the target assembly where temperatures exceed the melting points of the graphite and copper, which are around 3600 °C. 1085 °C respectively. While there are a few points where the temperature of the water exceeds 100 °C in the copper-water interface, the flow rate ensures that there is limited bubble formation, which could improve the water cooling rates.

In one alternative embodiment the graphite target assembly incorporates a neutron reflector assembly with an appropriate choice of sample location to maximize co-production of ²²⁵Ac along with any other potentially valuable isotopes via secondary neutron irradiation. Examples of such isotopes may include ⁶⁴Cu and ⁴⁷Sc.

Table 1 below shows illustrative operating parameters for the target assembly of FIG. 1 assuming an incident power of 10 kW and 20 kW. The relatively modest pressure change across the assembly (ΔP=1 bar) and the change in the cooling water temperature (ΔT=1.8 °C) suggests that the target will be relatively robust. While this design does not include temperature monitoring, which would need to be present to ensure proper thermal performance, alternative embodiments may include suitable temperature monitors.

In addition to the thermal behavior some consideration needs to be given to activation of the various target assembly components. The use of graphite and copper was motivated by a desire to minimize the production of long-term radionuclides in the target assembly. The one notable exception to this is the production of ⁷Be (t_{1/2}=52.22(6)d) in the graphite breakup target itself. This production cross section has been measured in graphite thick target deuteron breakup targets, and predicted activities are not expected to be significant, even based on continuous operation. Tritium production in the cooling water has not been assayed, but best practices suggests the use of a separate cooling water loop to minimize contamination. The primary copper activation product is likely to be ⁶⁴Cu (t_{1/2}=12.701(2)h), allowing for handling after a modest 5-day cooling period.

TABLE 1
Target assembly parameters for 10 kW and 20 kW operation

| Target parameters\Power | 10 kW B [symbol] Power | 20 kW B [symbol] Power |
|---|---|---|
| Materials | Frame: Easy-to-Machine 145 Copper; Coat: graphite; | |
| | Breakup Target: graphite, Tungsten | |
| Total Dimension | 10 cm × 7 cm × 3 cm | |
| Breakup target dimension | 1 cm in Diameter, 3 mm in thick | |
| Iniet inner diameter | 12.7 mm(half inch) in diameter | |
| Outlet inner diameter | 12.7 mm(half inch) in diameter | |
| Water Flow Rate [GPM] | 20 Gallon per minute | |
| Water linear velecity at inlet/outlet | 10 m/s | |
| Water linear velecity inside the target | <10 m/s | |
| Water Inlet temperature | 27 °C (300 K) | |
| Water outlet temperature | 28.9 °C (301.9 K) | 30.8 °C (303.8 K) |
| Pressure drop (from inlet to outlet) | 1 Bar [symbol] (10 Pa) | |
| Maxim Temperature in Copper-Water | 95 °C (368 K) | 160 °C (433 K) |
| interface | | |
| Maxium Temperature in Copper Frame | 480 °C | 834 °C |
| Maxium Temperature in Breakup Target | 1500 °C | 2890 °C |
| Flow type | Single Phase turbulent flow | Sub-cooled boiling tubulent flow |

Note [symbol] [symbol]
indicates data missing or illegible when filed

### Beryllium Target Assembly Design

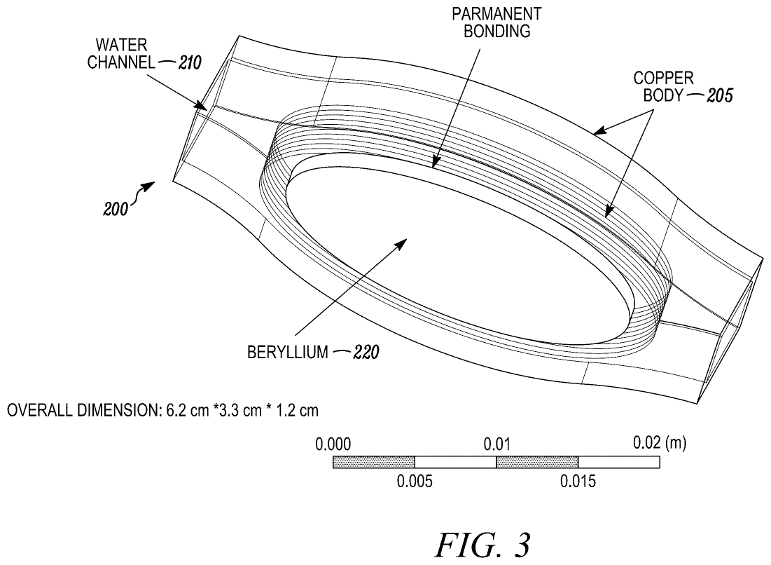

A second example of the target assembly described herein is shown in the schematic illustration of FIG. 3. One particular embodiment of this second example of the target assembly includes a beryllium break-up target and is designed so that it meets the following goals:
1. The target accepts 2 cm diameter 35 MeV deuteron beam;
2. A total beam power of 20 kW (e.g., beam intensity is 571 μA);
3. A beryllium break-up target;
4. A fixture or body of easy-to-machine 145 copper;
5. A fast-flowing liquid water coolant;
6. A permanent bonding between the breakup target and the copper body.

As shown in FIG. 3, the target assembly 200 includes a fixture or body 205 formed completely of 145 Copper. The copper body 205 includes a water channel 210. The copper body 205 supports a beryllium elliptic cylinder target 220 which may be permanently bonded to the copper body 205. Thermal conditions throughout the target assembly have been modeled assuming a pump rate of 4.2 gallons/minute, with an entry pressure of 2 bars.

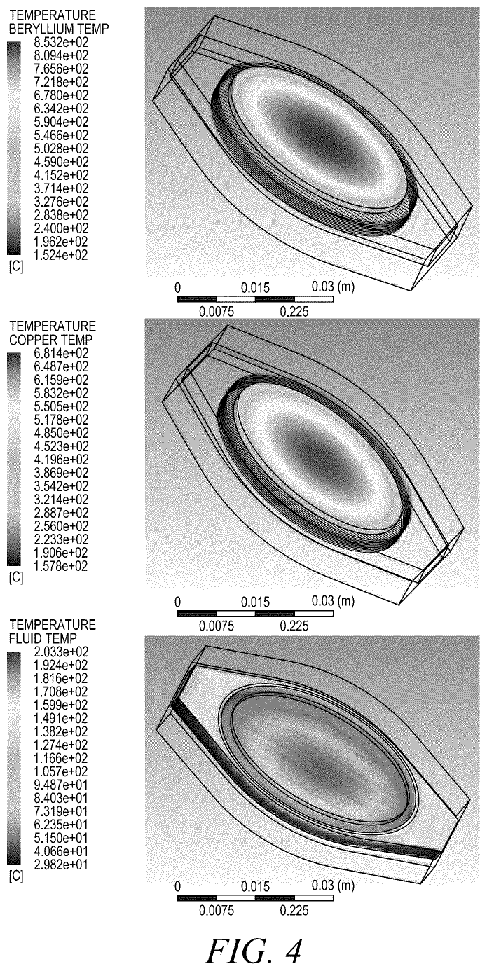

These thermal conditions for the different constituents of the target assembly of FIG. 3 are shown in FIG. 4. The top panel shows the outside surface temperature of the beryllium target. The middle panel shows a temperature map of the copper-beryllium interface. The bottom panel shows the temperature map for the water-body interface. There are no points in the target assembly where temperatures exceed the melting points of the beryllium and copper, which are around 1287 °C and 1085 °C respectively. While there are a few points where the temperature of the water exceeds 100 °C in the copper-water interface the flow rate ensures that there is limited bubble formation, which could enhance the water cooling rates.

Table 2 below shows illustrative operating parameters for the beryllium target assembly of FIG. 3 assuming an incident power of 20 kW. The relatively modest pressure changes across the target assembly (ΔP=1.06 bar) and the change in the cooling water temperature (ΔT=18 °C) suggests that the target will be relatively robust. While this design does not include temperature monitoring, which would need to be present to ensure proper thermal performance, alternative embodiments may include suitable temperature monitors.

In addition to the thermal behavior some consideration should be given to activation of the various target assembly components. Tritium production in the cooling water has not been assayed, but best practices suggest the use of a separate cooling water loop and the use of passive heat exchangers.

TABLE 2
beryllium target assembly parameters for 20 kW operation
Beryllium Target Parameters

| | |
|---|---|
| Beam Power | 20 kW |
| Beam Diameter | 2 cm |
| Angle Between Beam and Target's Normal Vector | 60° |
| Materials | Break-up target: Beryllium; Frame: Easy-to-Machine 145 |
| | Copper |
| Total Dimension | 6.2 cm × 3.2 cm × 1.1 cm (2.44″ × 1.26″ × 0.43″) |
| Breakup Target Dimension | Elliptical cylinder: a = 20 mm, b = 40 mm, h = 1.7478 mm |
| Inlet Inner Diameter | 8 mm ( 5/16″) |
| Outlet Inner Diameter | 8 mm ( 5/16″) |
| Water Flow Rate [GPM] | 4.2 Gallon/minutes |
| Water Linear Velocity at Inlet/Outlet | 6 m/s |
| Water Linear Velocity inside the Target | 10-11 m/s |
| Water Inlet Temperature | 27 °C |
| Water Outlet Temperature | 45 °C |
| Pressure Drop (from inlet to outlet) | 1.06 Bar (15.4 psi) |
| Maximum Temperature in Copper-Water Interface | 203 °C |
| Maximum Temperature in Copper Frame | 681 °C |
| Maximum Temperature in Beryllium | 853 °C |
| Flow type | Sub-cooled Boiling Turbulent Flow |

### Beryllium-Water Target Assembly Design

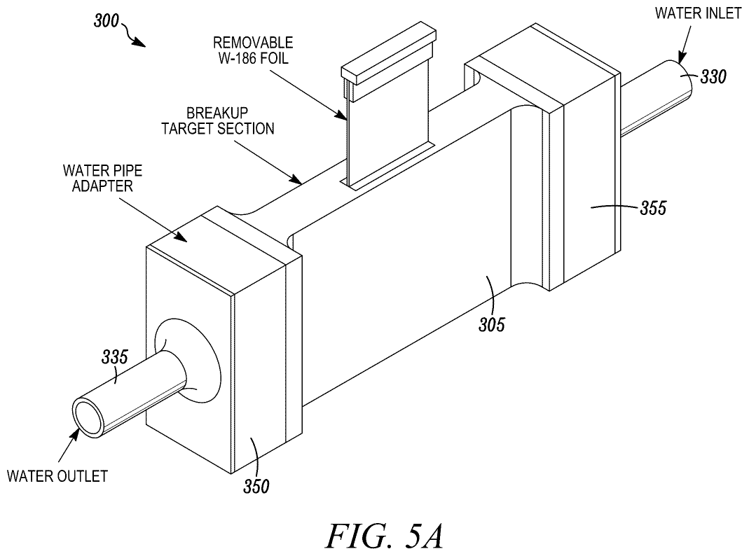

A third example of the target assembly includes a beryllium-water break-up target. The combination of beryllium and water provides an approach for efficient heat removal with little influence over neutron yield. The beryllium functions as the deuteron breakup material while the water serves as a coolant and also absorbs part of the deuteron energy. FIG. 5a is a schematic illustration of this example of the target assembly. As shown, the target assembly 300 includes a fixture or body 305 formed completely of 145 copper or Silicon Carbide (Si—C). The body 305 supports a target breakup section 310 (shown in FIG. 5b) that comprises a series of stacked target foils that include a series of beryllium foils 350 for producing neutrons via deuteron breakup and an additional optional target foil 340 such as tungsten-186 for the production of other medical isotopes. As shown, in some embodiments the additional target foil 315 may be configured as a removable target that allows it to be removed in situ and replaced with an alternative target foil.

As shown in FIG. 5b, one or more water channels 320 are formed between various ones of the individual target foils. FIG. 5a shows the water inlet 330 and water outlet 335 to which the water channels are in fluidic communication. The water inlet and outlet allow high speed water to flow through the water channels 320 to remove the heat. One advantage of this design is that it increases the size of the equivalent beryllium-water interface. For instance, in one particular implementation the equivalent beryllium-water interface area can be increased by a factor of 4~6 while the total heat transfer through the interface is reduced, with about ⅓ of the total energy being deposited into the water directly. Thus, the heat flux through the beryllium-water interface is reduced. Since the particular embodiment of the target assembly shown in FIGS. 5a and 5b has a rectangular cross-section, the target assembly includes waterpipe adapters 350 and 355 for establishing the fluidic communication between the circular water inlet and outlet and the water channels. Of course, more generally the body 305 of the target assembly 300 may have any suitable cross-sectional shape.

One particular implementation of this third example of the target assembly is designed so that it meets the following goals:
1. Target thickness is less than 1 cm;
2. The target accepts 1.5 cm diameter 35 MeV deuteron beam with vertical incidence;
3. A total beam power of 20 KW (e.g., 571 μA);
4. A fixture or body of an easy-to-machine material;
5. Maximum temperate less than 300 °C;
6. A fast-flowing liquid water coolant;
7 Removable foil (tungsten-186, etc.) for other medical isotopes production as an additional benefit.

If the additional target foil is made of tungsten-186, a high specific activity of ¹⁸⁶Re occurs through the ¹⁸⁶W (d,2n)¹⁸⁶Re reaction. ¹⁸⁶Re is a radioisotope with a half-life of 90 hours that emits beta particles and gamma rays and is used in cancer treatment and diagnostic imaging technique.

Illustrative design parameters of the target assembly shown in FIG. 5 are listed in Table 3.

TABLE 3
Beryllium-Water target assembly parameters for 20 kW operation
beryllium-Water HPTS Parameters

| | |
|---|---|
| Beam Power | 20 kW |
| Angle of Incidence | 0° |
| Materials | beryllium, tungsten, 145 Copper |
| Coolant | Water |
| Total Dimension | 7.8 cm3-3 cm × 1.7 cm (3.07″ × 1.18″ × 0.67″) |
| Breakup Target Thickness | Two Sheets: 1 mm, 1.54 mm |
| tungsten Foil Thickness | 0.11295 mm |
| Water Flow Rate [GPM] | 6.8 Gallon/minutes |
| Water Linear Velocity inside the Target | 10 m/s |
| Water Inlet Temperature | 27 °C |
| Water Outlet Temperature | 42.1 °C |
| Pressure Drop (from inlet to outlet) | 0.8 Bar (11.6 psi) |
| Heat Flux at the beryllium-Water Interface | 1.62 kW/cm² |
| Critical Heat Flux (CHF) (given by Celata et. al.) | 2.24 kW/cm² |
| Maximum Temperature in beryllium-Water | 140 °C |
| Interface | |
| Maximum Temperature in Breakup Target | 189 °C |
| Flow type | Sub-cooled Boiling Turbulent Flow |

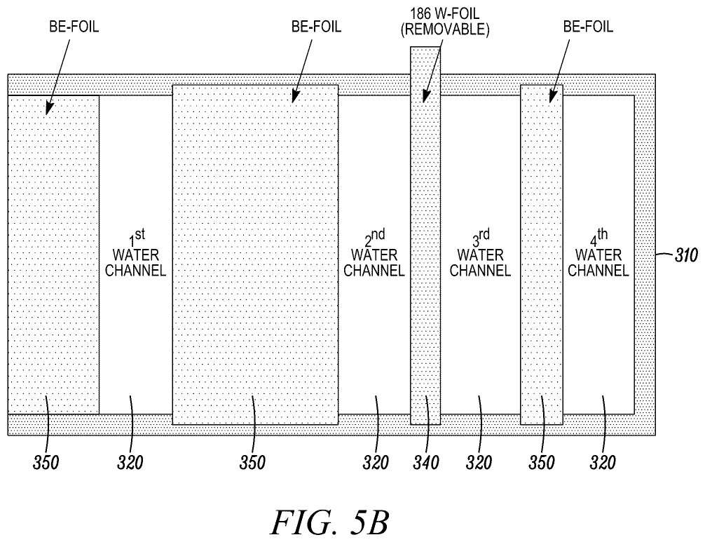

FIGS. 6a and 6b show one alternative embodiment of the target assembly shown in FIGS. 5a and 5b. However, in FIGS. 6a and 6b the target breakup section 310 includes a permanent additional target foil (e.g., W-186) rather than a removable target foil 340 as shown in FIGS. 5a and 5b. Consequently, all the foils in this embodiment are permanent in design. In one implementation of this embodiment two water channels are provided and the thickness of the target is reduced by 1.2 mm, which will increase the neutron efficiency for the secondary target (which is not shown in FIGS. 5 and 6, but which may be located behind the breakup target section). One particular implementation of this target assembly is designed so that it meets the following goals:
1. Target thickness is less than 0.6 cm;
2. A 1.5 cm diameter 35 MeV deuteron beam with vertical incidence;
3. A total beam power of 10 KW (e.g., beam intensity is 286 μA);
4. A fixture or body of easy-to-machine material;
5. Maximum temperate less than 300 °C;
6. A fast-flowing liquid water coolant.

Illustrative design parameters of the target assembly shown in FIG. 6 are listed in Table 4.

TABLE 4
Beryllium-Water target assembly design parameters for 10 kW operation
beryllium-Water HPTS Parameters

| | |
|---|---|
| Beam Power | 10 kW |
| Angle of Incidence | 0° |
| Materials | beryllium, tungsten, 145 Copper |
| Coolant | Water |
| Total Dimension | 7.8 cm × 3 cm × 1.7 cm (3.07″ × 1.18″ × 0.67″) |
| Breakup Target Thickness | Two Sheets: 1.8919 mm, 1.1243 mm |
| tungsten Foil Thickness | 0.1114 mm |
| Water Flow Rate [GPM] | 3.4 Gallon/minutes |
| Water Linear Velocity inside the Target | 10 m/s |
| Water Inlet Temperature | 27 °C |
| Water Outlet Temperature | 42.1 °C |
| Pressure Drop (from inlet to outlet) | 0.8 Bar (11.6 psi) |
| Heat Flux at the beryllium-Water Interface | 1.29 kW/cm² |
| Critical Heat Flux (CHF) (given by Celata et. al.) | 2.24 kW/cm² |
| Maximum Temperature in beryllium-Water | 140 °C |
| Interface | |
| Maximum Temperature in Breakup Target | 234 °C |
| Flow type | Sub-cooled Boiling Turbulent Flow |

### Liquid Lithium Target Assembly Design

In yet another embodiment of the target assembly described herein, liquid lithium is employed as the neutron production target due its ability to quickly remove heat and the proportionally higher expected neutron yields due to an increased range of the deuteron beam in the production target. This embodiment also allows the co-loaded ¹⁸⁶W target to be easily removed for chemical processing following irradiation. This target assembly design would likely produce ²²⁵Ac at a 30% higher rate per unit target mass.

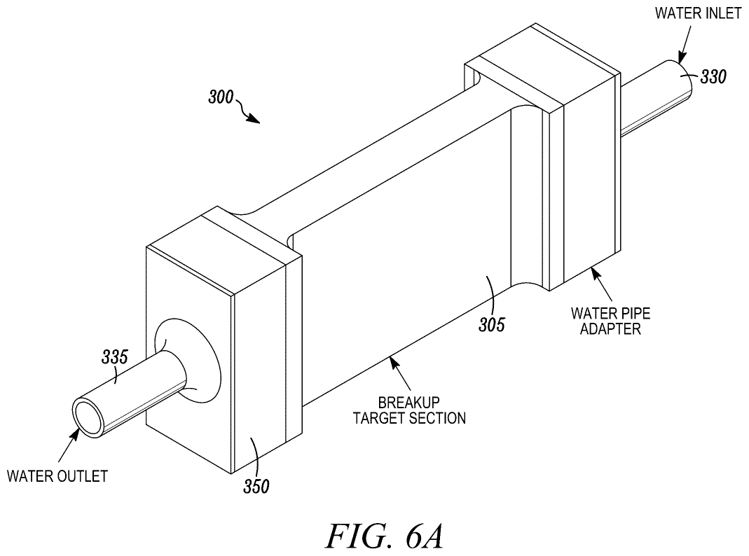

FIG. 7 shows one example of the liquid lithium target assembly for use with an illustrative deuteron beam power of 20 kW. The liquid lithium target assembly 400 includes a stainless steel/titanium fixture or tube 410, which is illustratively shown as having a rectangular cross-section, although more generally the tube 410 may have any suitable configuration. The liquid lithium flows through the conduit 420 extending through the tube 410. The tube 410 serves to transfer the heat deposited on the lithium and the tube 410. For a fully developed turbulent flow of liquid metal in smooth circular tubes with constant surface heat flux a correlation of the following form is recommended (see Skupinski, E., Tortel, J., & Vautrey, L. (1965). Determination des coefficients de convection d′un alliage sodium-potassium dans un tube circulaire. International Journal of Heat and Mass):

$${Nu}_{D} = 4.82 + 0.0185 {Pe}_{D}^{0.827} , {q}^{″} = constant$$

for 3× 10⁻³<Pr<5×10⁻², 3.6×10³<Re_{D}<9.05×10⁵, 10²<Pe_{D}<10⁴ where Pr is the Prandtl number, Re_{D} represent the Reynolds number, and Pe_{D} stands for the Peclet number.

$${Re}_{D} = \frac{ρ {uD}_{h}}{μ}$$

$${Pe}_{D} = {Re}_{D} \times Pr$$

where Dₕ is the hydraulic diameter, and for noncircular tube, is defined as

$${D}_{h} = \frac{4 {A}_{c}}{P}$$

where A_{c} and P are the flow cross-sectional area and the wetted perimeter, respectively.

The heat flux q″ is given as

$${q}^{″} = ( {T}_{w} - {T}_{f} ) h = ( {T}_{w} - {T}_{f} ) \frac{λ {Nu}_{D}}{{D}_{h}}$$

where λ is the thermal conductivity of the fluid.

As further shown in FIG. 7, a beryllium window 430 serves as the window of the tube 410 on which the deuteron beam is incident. An additional target foil 440 such as tungsten-186 may be located within the conduit, which is illustratively shown as being located on the bottom inner surface of tube 410, although more generally it may be located elsewhere within the conduit 420.

The dimensions of the window, tungsten foil and tube are determined by the beam energy loss, which was calculated by the software package Elast. Illustrative dimensions and other parameters associated with some embodiments of the target assembly of FIG. 7 are shown in Table 5.

TABLE 5
Parameters of the Liquid Lithium Target Design.

| | | Beam Projection Angle | |
|---|---|---|---|
| Parameters | Notes | Θ = 60° | Θ = 0° |
| Beam Power | | 20 kW | |
| Beam Diameter | | 1.5 cm | |
| Dimension | A | 15 mm | 15 mm |
| | B | 6.165 mm | 12.33 mm |
| | C | >1 mm | >1 mm |
| | D | 30 mm | 15 mm |
| | L | 50 mm | 35 mm |
| Liquid Lithium Velocity | | 6 m/s | 10 m/s |
| Volume Flow Rates | | 8.8 GPM | 29.3 GPM |
| Input Temperature | | 200 °C | 200 °C |
| Output Temperature | | 216 °C | 204.8 °C |
| tungsten Foil Thickness | | 55.6 μm | 111.2 μm |
| Tungsten Foil Temperature | | 500 °C | 700 °C |
| Window Thickness | beryllium | 0.27 mm | 0.54 mm |
| (2.3 MeV energy loss) | | | |

In some embodiments the additional target foil 440 (e.g., tungsten-186) is removable to get a high specific activity of ¹⁸⁶Re through the ¹⁸⁶W (d, 2n)¹⁸⁶Re reaction. However, many other isotopes of potential commercial value could be coproduced using the same approach. A list of several of these can be found in Table 6.

TABLE 6
Potential isotopes production.

| Isotope (half-life) | Use/Application | Reaction |
|---|---|---|
| ^{193m}Pt (4.33 days) | Auger cancer therapy | ¹⁹³Ir (d, 2n) |
| ⁸⁶Y (14.74 hours) | Positron Emission Tomography | ⁸⁶Sr(d, 2n) |
| ¹¹¹In (2.84 days) | Auger cancer therapy | ^{nat}Cd(d, xn) |
| ⁵¹Cr (27.70 days) | Single-Photon Emission Computed | ⁵¹V (d, 2n) |
| | Tomography | |
| ^{99m}Tc (6.01 hours) | Single-Photon Emission Computed | ¹⁰⁰Mo(d, x) |
| | Tomography | |
| ⁴⁴Sc (3.97 hours) | Positron Emission Tomography | ⁴⁴Ca(d, 2n), |
| | | ⁴³Ca(d, n), |
| | | ⁴⁵Sc(d, 3n)⁴⁴Ti |
| ⁵²Mn (5.591 days) | Positron Emission Tomography | ⁵²Cr(d, 2n) |
| ⁵⁵Co (17.53 hours) | Positron Emission Tomography | ⁵⁴Fe(d, n) |
| ^{58m}Co (9.10 hours) | Auger cancer therapy | ⁵⁷Fe(d, n) |
| ⁶¹Cu (3.339 hours) | Positron Emission Tomography | ⁶⁰Ni(d, n) |
| ⁶⁸Ga (67.71 minutes) | Positron Emission Tomography | ⁶⁸Zn(d, 2n) |
| ⁷²As (26.0 hours) | Positron Emission Tomography | ^{nat}Ge(d, x) |
| ⁸⁹Zr (78.41 hours) | Positron Emission Tomography | ⁸⁹Y (d, 2n) |
| ^{110m}In (69.1 minutes) | Positron Emission Tomography | ¹¹⁰Cd(d, 2n) |
| ⁶⁴Cu (12.701 hours) | Positron Emission Tomography | ⁶⁴Ni (d, 2n) |
| ¹⁰³Pd (16.991 days) | Auger cancer therapy | ¹⁰³Rh(d, 2n) |
| ^{114m}In (49.51 days) | Auger cancer therapy | ¹¹⁴Cd(d, 2n) |
| ¹⁶⁹Yb (32.018 days) | Brachytherapy | ¹⁶⁹Tm(d, 2n) |
| ¹⁷⁷Lu (6.64 days) | Beta therapy | ¹⁷⁶Yb(d, |
| | | p)¹⁷⁷Yb, |
| | | ¹⁷⁶Yb(d, x) |
| ¹⁸⁶Re (3.719 days) | Beta therapy | ¹⁸⁶W(d, 2n) |
| ¹⁹²Ir (73.829 days) | Brachytherapy | ¹⁹²Os(d, 2n) |
| ²³⁰U (20.8 days) | Targeted alpha therapy | ²³¹Pa(d, 3n) |
| ⁶⁷Cu (61.83 hours) | Beta therapy | ⁷⁰Zn(d, x) |
| ²⁰³Pb (51.92 hours) | Single-Photon Emission Computed | ²⁰³Tl(d, 2n) |
| | Tomography | |
| ¹⁵⁵Tb (5.32 days) | Theranostics | ¹⁵⁵Gd(d, 2n) |
| ⁴⁵Ti (184.8 minutes) | Positron Emission Tomography | ⁴⁵Sc(d, 2n) |
| ¹¹⁹Sb (38.19 hours) | Auger cancer therapy | ¹¹⁸Sn(d, n), |
| | | ¹¹⁹Sn(d, 2n) |
| ¹⁶⁵Er (10.36 hours) | Auger cancer therapy | ¹⁶⁵Ho(d, 2n) |
| ⁷¹Ge (11.43 days) | Auger cancer therapy | ⁷¹Ga(d, 2n) |
| ¹⁹⁷Hg (64.14 hours) | Auger cancer therapy | ¹⁹⁷Au(d, 2n) |
| ¹⁸⁹Ir (13.2 days) | Auger cancer therapy | ¹⁸⁸Os(d, n) |
| ¹³⁵La (19.5 hours) | Auger cancer therapy | ¹³⁵Ba(d, 2n) |
| ^{180m}Hf (8.154 hours) | Auger cancer therapy | ¹⁸⁰Hf(d, 2n) |
| ¹⁰⁷Cd (6.50 hours) | Auger cancer therapy | ¹⁰⁷Ag(d, 2n) |

Liquid lithium pumps suitable for use in conjunction with the target assembly shown in FIG. 7 are available (see, for example, https://creativeengineers.com/alkali-metal-engineering/specialized-pumps-flow-meters-for-use-with-liquid-metal/electromagnetic-pumps/).

### Illustrative Range of Parameters

Presented below are a few illustrative variants on the different embodiments of the target assembly described above.

The beryllium break-up target in the target assembly shown in FIG. 3 may have any suitable shape, such as circular or elliptical, or it may cover the whole front surface of the fixture or body (using, for example, explosive welding method to bond the beryllium to the body). It the beryllium break-up target is round or elliptical, in some embodiments the diameter may be in the range of 10 mm to 40 mm; if the beryllium break-up target covers the whole front surface of the target assembly, then it can have the same dimensions as that of the target assembly. The thickness of the beryllium b can be, by way of example, 0.2 mm to 5 mm. The water flow velocity u inside the flow tunnel, can be, by way of example, 2 m/s to 30 m/s. The volume flow rates can be, by way of example, 1 GPM to 20 GPM.

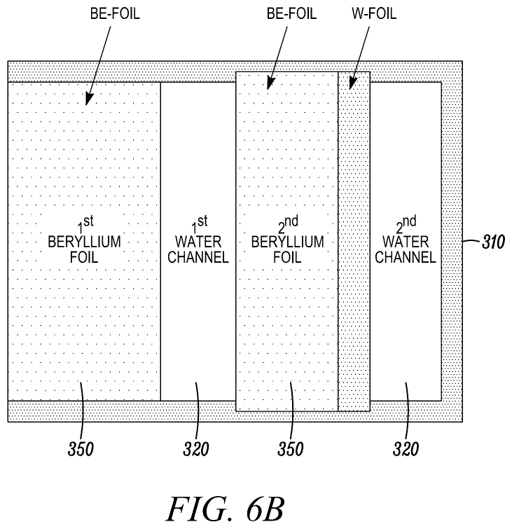

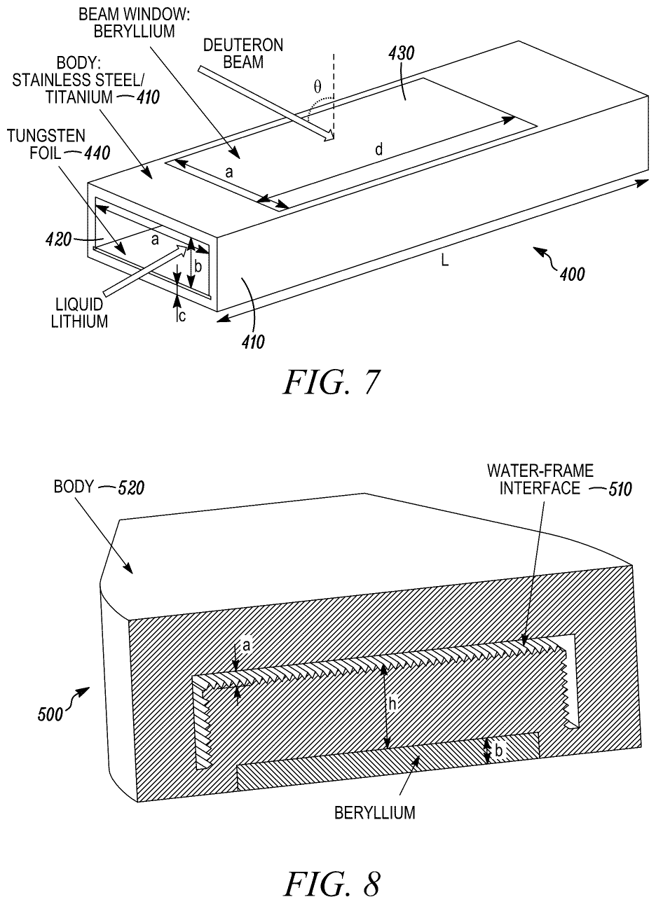

The fixture or body material of the target assembly shown in FIG. 3 can be copper, aluminum, silver or any other material with a good thermal conductivity. In some embodiments the interface between the water in the water channels and the body has a roughened surface such as a V-shaped wavy surface, FIG. 8 shows an embodiment 500 of the beryllium target assembly of FIG. 3 in which such a roughened surface is provided at the interface 510. In some cases the roughened surface may be corrugated or indented, or have low fins to increase the surface heat transfer rates. Examples of such surfaces along which the water may flow are shown in FIGS. 9a-9g.

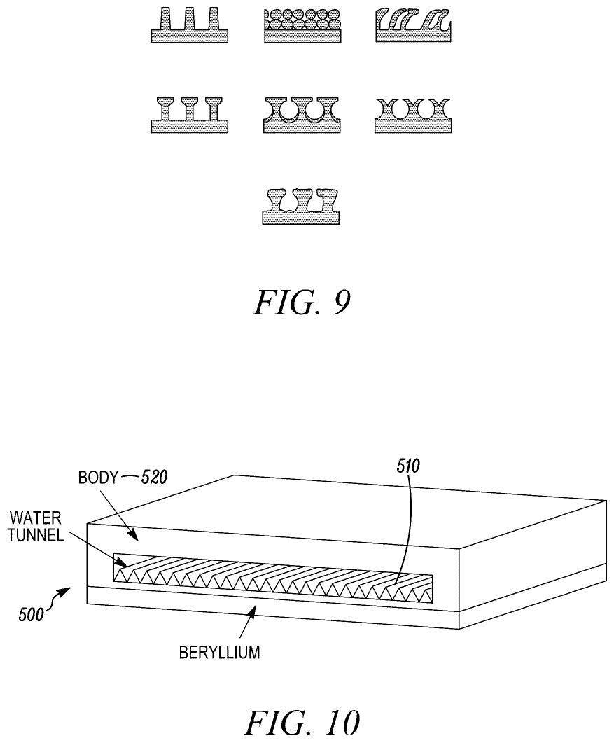

Referring again to FIG. 8, the width of the water channel can be, by way of example, 0.1 mm to 10 mm, and the value of h can be 0 mm to 10 mm. In some embodiments it is also possible that the parameter h in FIG. 8 is 0, in which case the shape of the target will be as shown in FIG. 10, which shows a schematic diagram of yet another alternative embodiment which has a simpler geometry shape.

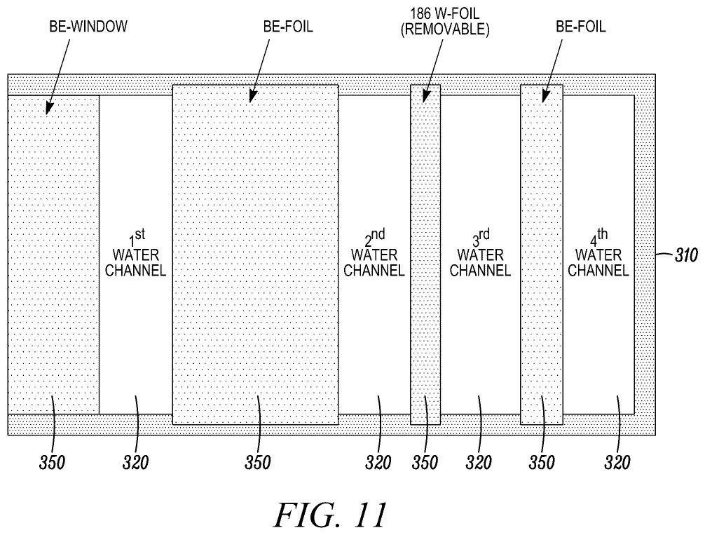

FIG. 11 shows an alternative embodiment of the break-up target section 310 for the target assembly shown in FIGS. 5 and 6. In some embodiments the number of water channels 320 may range, for example, from 1 to 10, the width of the water channels 320 can be, for example, from 0.1 mm to 5 mm and the thickness of the beryllium foils 350 can be, for example, 0.1 mm to 5 mm. The water flow velocity u inside the flow tunnel, can be, for example, from 2 m/s to 30 m/s and the volume flow rates can be, for example, from 0.2 GPM to 20 GPM.

For the embodiment of the target assembly shown in FIG. 7 which employs liquid lithium, the deuteron beam can be arranged at any reasonable angle with respect to the target surface (such as 90°, or vertical incidence) and the tungsten foil can be placed somewhere inside the flow channel, and not necessarily at the bottom of the flow channel as depicted in FIG. 7.

### Illustrative Examples

Several particular illustrative, non-limiting examples of the target assembly described herein are presented below.

In one embodiment, the target assembly includes a target and a fixture supporting the target. The target is configured to produce multi-MeV neutrons via deuteron breakup. The target has an elliptical beam strike area less than 3 cm² with a major-to-minor axis ratio of less than 2:1 for a deuteron beam power density that is greater than or equal to 6 kW/cm². The fixture includes a water channel conducting water therethrough with a water pressure differential through the fixture that is less than or equal to 1.1 bar with a water flow rate less than 4.5 gallons per minute (gpm). The fixture has a thickness less than or equal to 3 cm and is formed from one or more materials that avoid the production of activation products with lifetimes exceeding 13 hours.

In some particular implementations the target may be a graphite target or a beryllium target.

In some particular implementations the fixture may be formed from copper.

In some particular implementations the fixture may have a thickness less than or equal to 3.2 cm.

In another embodiment, the target assembly includes a target having one or more first target foils for producing multi-MeV neutrons via deuteron breakup. A fixture supports the target. The target has a circular beam strike area with a diameter not larger than 1.5 cm for a deuteron beam power density that is greater than or equal to 11.32 kW/cm². The fixture includes a plurality of water channels conducting water therethrough with a water pressure differential through the fixture that is less than or equal to 1.0 bar with a water flow rate less than 7 GPM (gallons per minute). The fixture has a thickness less than or equal to 1.0 cm and is formed from one or more materials that avoid production of activation products with lifetimes exceeding 13 hours.

In some particular implementations the target may include a second target foil for production of medical isotopes. The second target foil and the one or more first target foils are arranged in a stack. The second target foil may be in situ removable for separate processing. The one or more first target foils may include a plurality of first target foils arranged in a stack. The plurality of water channels may be located between adjacent ones of the first target foils and/or between one of the first target foils and the second target foil. The first target foil may include beryllium and the second target foil may include tungsten. The fixture may be formed from copper or Si—C. The fixture may have a thickness less than or equal to 0.7 cm.

In another embodiment, the target assembly includes a fixture and a liquid lithium target. The fixture has a conduit extending therethrough and the liquid lithium target has liquid lithium flowing through the conduit for producing multi-MeV neutrons via deuteron breakup using a deuteron beam power that is greater than or equal to 6 kW/cm². The liquid lithium has a flow rate of less than or equal to 8.8 gpm for a target inclination of no more than 60° and a pressure differential less than or equal to 0.014 Bar. The fixture is formed from one or more materials that avoid production of activation products with lifetimes exceeding 13 hours.

In other embodiments the various target assemblies described above may be used in a method for producing a multi-MeV neutron beam. The multi-MeV neutron beam may be used for a variety of purposes such as isotope production or materials damage studies, for example

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A target assembly, comprising:
a target for producing multi-MeV neutrons via deuteron breakup; and
a fixture supporting the target, the target having an elliptical beam strike area less than 3 cm² with a major-to-minor axis ratio of less than 2:1 for a deuteron beam power density that is greater than or equal to 6 kW/cm², the fixture including a water channel conducting water therethrough with a water pressure differential through the fixture that is less than or equal to 1.1 bar with a water flow rate less than 4.5 gallons per minute (gpm), the fixture having a thickness less than or equal to 3 cm and being formed from one or more materials that avoid the production of activation products with lifetimes exceeding 13 hours.

2. The target assembly of claim 1, wherein the target is a graphite target.

3. The target assembly of claim 1, wherein the target is a beryllium target.

4. The target assembly of claim 1, wherein the fixture is formed from copper.

5. The target assembly of claim 1, wherein the fixture has a thickness less than or equal to 3.2 cm.

6. A target assembly, comprising:
a target that includes one or more first target foils for producing multi-MeV neutrons via deuteron breakup; and
a fixture supporting the target, the target having a circular beam strike area with a diameter not larger than 1.5 cm for a deuteron beam power density that is greater than or equal to 11.32 kW/cm², the fixture including a plurality of water channels conducting water therethrough with a water pressure differential through the fixture that is less than or equal to 1.0 bar with a water flow rate less than 7 GPM (gallons per minute), the fixture having a thickness less than or equal to 1.0 cm and being formed from one or more materials that avoid production of activation products with lifetimes exceeding 13 hours.

7. The target assembly of claim 6 wherein the target includes a second target foil for production of medical isotopes, the second target foil and the one or more first target foils being arranged in a stack.

8. The target assembly of claim 7, wherein the second target foil is in situ removable for separate processing.

9. The target assembly of claim 7, wherein the one or more first target foils includes a plurality of first target foils arranged in a stack, the plurality of water channels being located between adjacent ones of the first target foils and/or between one of the first target foils and the second target foil.

10. The target assembly of claim 6, wherein the first target foil includes beryllium.

11. The target assembly of claim 7, wherein the second target foil includes tungsten.

12. The target assembly of claim 6, wherein the fixture is formed from copper or Si—C.

13. The target assembly of claim 6, wherein the fixture has a thickness less than or equal to 0.7 cm.

14. A target assembly, comprising:
a fixture having a conduit extending therethrough; and
a liquid lithium target having liquid lithium flowing through the conduit for producing multi-MeV neutrons via deuteron breakup using a deuteron beam power that is greater than or equal to 6 kW/cm², the liquid lithium having a flow rate of less than or equal to 8.8 gpm for a target inclination of no more than 60° and a pressure differential less than or equal to 0.014 Bar, the fixture being formed from one or more materials that avoid production of activation products with lifetimes exceeding 13 hours.

15. A method of producing a multi-MeV neutron beam using the target assembly of claim 1.

16. A method of producing a multi-MeV neutron beam using the target assembly of claim 6.

17. A method of producing a multi-MeV neutron beam using the target assembly of claim 14.

18. The method of claim 15, wherein the multi-MeV neutron beam is used for isotope production.

19. The method of claim 15, wherein the multi-MeV neutron beam is used for materials
damage studies.
